(19) United States
(12) Patent Application Publication
(10) Pub. No.: US 2015/0130395 A1
(43) Pub. Date: May 14, 2015

(54) Graphene-in-structure electrical energy storage

(71) Applicant: Kreg Rice, Houston, TX (US)

(72) Inventor: Kreg Rice, Houston, TX (US)

(73) Assignee: Kreg Louis Rice, Houston, TX (US)

(21) Appl. No.: 14/215,025

(22) Filed: Mar. 16, 2014

Related U.S. Application Data
(60) Provisional application No. 61/903,373, filed on Nov. 12, 2013.

(51) Int. Cl. H01G 11/32; H02J 7/35; B60L 11/18; H02J 7/34

(52) U.S. Cl. CPC H01G 11/32; H02J 7/345; H02J 7/35; B60L 11/1809
USPC 320/101; 320/167; 320/107; 320/109; 320/114

(57) ABSTRACT

The problem of enabling a physical system to store and access a large amount of electrical energy while keeping the weight of the system as low as possible is solved by including graphene in the structure of the system. Supercapacitive graphene-in-structure electrical energy storage is applicable to a wide variety of electrical applications, including but not limited to electronics devices, power tools, vehicles, airplanes and buildings.

### BRIEF DESCRIPTION OF THE DRAWINGS

FIG. 1 is a conceptual view of the invention depicting the context of the system structure, electrical voltage/current load, and external power access.

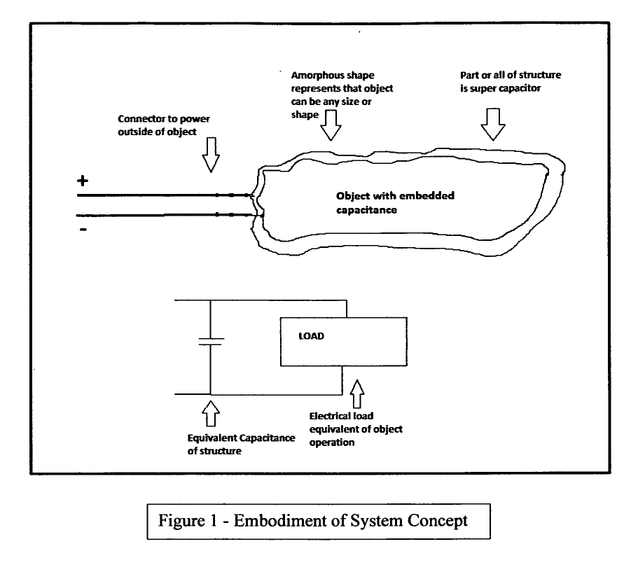

FIG. 2 is a conceptual view of the system structure, showing graphene layers interleaved between dielectric material layers.

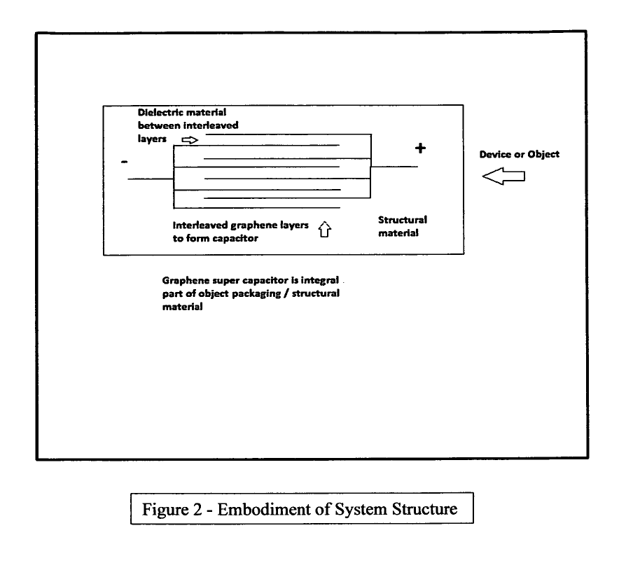

### DESCRIPTION AND OPERATION

### Main Embodiment

In a preferred embodiment of the invention, a vehicle chassis is constructed using graphene-in-structure, thereby providing a large electrical charge reservoir. The vehicle chassis is able to receive charge rapidly from an external power source, because of the supercapacitive properties of graphene. The operation of the vehicle draws electrical power from the vehicle chassis, reducing or eliminating the requirement for batteries or fuel cells.

### Alternate Embodiments

In an alternative embodiment of the invention, a case for electronics is constructed using graphene-in-structure, thereby providing an electrical charge reservoir. The electronics case is able to receive charge rapidly from an external power source, because of the supercapacitive properties of graphene. The operation of the electronics draws electrical power from the electronics case, reducing or eliminating the requirement for batteries or direct power connection.

In another alternative embodiment of the invention, a hand-held power tool body is constructed using graphene-in-structure, thereby providing an electrical charge reservoir. The power tool body is able to receive charge rapidly from an external power source, because of the supercapacitive properties of graphene. The operation of the power tool draws electrical power from the power tool body, reducing or eliminating the requirement for batteries or direct power connection.

In another alternative embodiment of the invention, a building structure is constructed using graphene-in-structure, thereby providing an electrical charge reservoir. The building structure is able to receive charge rapidly from an external power source, because of the supercapacitive properties of graphene. The building functions as an electrical power reservoir, providing electrical power for building operations or as a fueling station for charging vehicles. In another alternative embodiment of the invention, an airplane structure is constructed using graphene-in-structure, thereby providing an electrical charge reservoir. The building structure is able to receive charge rapidly from an external power source, because of the supercapacitive properties of graphene. The building functions as an electrical power reservoir, providing electrical power for building operations or as a fueling station for charging vehicles.

### Description of Fabrication

One method how to create a structural capacitor is to interweave continuous layers of a strip of graphene coated on both sides with dielectric material with an additional graphene strip alternating the layers back and forth over a form board to create the desired shape. Multiple shapes can be connected together to form an object with a specific function powered by the structural capacitance.

A second method of how to create a structural capacitor is to wrap a continuous sheet of graphene-dielectric-graphene-dielectric around a form until desired shape is obtained. This allows for the creation of a large capacitive structure that can then provide energy as well as structural shape to the desired of the object.

### CONCLUSIONS, RAMIFICATIONS, AND SCOPE

Graphene-in-structure electrical energy storage reduces or eliminates the requirement for batteries, fuel cells, or connected electric power in a variety of applications including: hand-held electronic devices such as cell phones and computer tablets; power tools; electronic devices such as computers, monitors, computer peripherals, TVs, and entertainment electronics; vehicles such as bikes, motorbikes, cars, vans, SUVs, RVs, buses, trucks, trains, boats, ships, airplanes, helicopters, and spacecraft; and buildings such as homes, garages, off-shore/on-shore power generation storage systems, and service stations.

Advantages over current energy storage devices and processes include rapid charging replacing slow refueling; reduced weight of energy source and structure; replacement of expensive, environmentally impactful metals with carbon components; simplicity of establishing supporting network of fueling stations for vehicle operation, as compared to natural gas, diesel or gasoline.

What is claimed is:

1. A method for storing electrical energy in the structure of a system, said method comprising the steps of
integrating a graphene supercapacitor to said system structure;
charging said graphene supercapacitor from an external power source; and
accessing the stored charge from said graphene supercapacitor,
whereby said electrical energy may be rapidly stored and accessed, with weight, time and durability advantages over conventional electrical energy storage methods.

2. The method of claim 1 wherein integrating said graphene supercapacitor to said system structure comprises the steps of:
coating flat panels of graphene on both sides with dielectric, creating coated graphene panels;
interleaving flat panels of uncoated graphene with said coated graphene panels, creating interleaved panels of coated and uncoated graphene; and
forming said interleaved panels of coated and uncoated graphene over a structural form to create a desired shape for integration with said system structure.

3. The method of claim 1 wherein integrating said graphene supercapacitor to said system structure comprises the steps of:
layering alternately one or more graphene panels with one or more dielectric panels, creating a layered graphene-dielectric panel; and
wrapping said layered graphene-dielectric panel over a structural form to create a desired shape for integration with said system structure.

4. The method of claim 1 wherein said external power source is a renewal energy source including but not limited to solar energy, wind energy, or geothermal energy.

5. A device for storing electrical energy in the structure of a system, said device comprising:
a graphene supercapacitor, said graphene supercapacitor constructed as integral to said system structure;
a means for charging said graphene supercapacitor from an external power source; and
a means for accessing the stored charge from said graphene supercapacitor, whereby said device may rapidly store and access said electrical energy, with weight, materials, charging time, environmental, and durability advantages over conventional electrical energy storage devices.

6. The device of claim 5 wherein said graphene supercapacitor comprises:
panels of graphene, interleaved with panels of graphene coated with dielectric.

7. The device of claim 5 wherein said graphene supercapacitor comprises:
panels of graphene, interleaved with panels of dielectric.

8. The device of claim 5 wherein said system is a vehicle, including but not limited to vehicles such as bikes, motorbikes, cars, vans, SUVs, RVs, buses, trucks, trains, boats, ships, airplanes, helicopters, and spacecraft.

9. The device of claim 5 wherein said system structure functions as a re-charging station for batteries.

10. The device of claim 5 wherein said system is a building, including but not limited to buildings such as homes, garages, off-shore/on-shore power generation storage systems, and service stations.

11. The device of claim 10 wherein said building structure is a fueling station for vehicles,
whereby establishing supporting networks of said fueling stations for vehicle operation is financially and environmentally advantageous over conventional natural gas, diesel or gasoline fueling networks.

12. The device of claim 10 wherein said building structure is a charge storage facility for electrical power.

13. The device of claim 12 wherein said electrical power comes from renewal energy sources including but not limited to solar energy, wind energy, or geothermal energy.

14. The device of claim 5 wherein said system is a hand-held power tool.

15. The device of claim 5 wherein said system is a case for a hand-held power tool.

16. The device of claim 5 wherein said system is a hand-held electronic device including but not limited to a cell phone or computer tablet.

17. The device of claim 5 wherein said system is an electronic device including but not limited to a computer, monitor, computer peripheral, TV, or entertainment electronic device.

18. The device of claim 5 wherein said system is furniture.

19. The device of claim 5 wherein said system is used for cooking.

20. The device of claim 5 wherein said system is used for freezing or refrigeration.
